(19) United States
(12) Patent Application Publication
(10) Pub. No.: US 2012/0150969 A1
(43) Pub. Date: Jun. 14, 2012

(54) DYNAMICALLY ENABLING USER LOGGING ACROSS DISTRIBUTED SYSTEMS

(75) Inventors: Jeffrey Reed, Bothell, WA (US); Conal Walsh, Vancouver (CA)

(73) Assignee: MICROSOFT CORPORATION, Redmond, WA (US)

(21) Appl. No.: 12/965,554

(22) Filed: Dec. 10, 2010

(51) Int. Cl. G06F 15/16

(52) U.S. Cl. 709/206

(57) ABSTRACT

Dynamic logging of messages in a distributed system is enabled by processing message tags. Tags to be processed may be included in message headers or as message parameters. Different components of the distributed system may determine which message is to be logged based on the tag included in the message. Detection of a tag may initiate logging by a relevant system component.

### BACKGROUND

As an alternative to Public Switched Telephone Network (PSTN) systems, cellular phone networks have proliferated over the last decades, where users with cellular phones have access to one or more networks at almost any location. Also a recent development is the wide spread use of Voice over IP (VOIP) telephony, which uses internet protocol (IP) over wired and wireless networks. With the availability of such diverse types of communication networks and devices capable of taking advantage of various features of these networks, enhanced communication systems bring different communication networks together providing until now unavailable functionality such as combining various modes of communication (e.g. instant messaging, voice calls, video communications, etc.). This technology is also referred to as unified communications (UC). A network of servers manages end devices capable of handling a wide range of functionality and communication while facilitating communications between the more modern unified communication network devices and other networks (e.g. PSTN, cellular, etc.).

Distributed server components in enhanced communication systems and similar environments expose certain configurations for system administrators to tailor server behavior according to their needs. When attempting to diagnose the cause of a failure in a distributed system, such as a unified communication system, determining which error logs to collect may be a challenge for administrators. Client side logs may often contain an incomplete picture of why an end user scenario is failing, and administrators may be forced to turn to server logs for more information. Determining which server logs to collect is challenging itself, because distributed systems may involve numerous components, any of which could encounter a failure, components may run in different processes, and components may run on multiple machines. Additionally, production environments may often contain large volumes of users and traffic. Log files may become large and roll over quickly under such loads making the contents noisy and incomplete.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to dynamically enabling user logging by processing message tags. Message tags may be headers or parameters defined by message protocols. The tags may be used to identify which message dialogs to log. Detection of a predetermined tag may initiate logging by system components.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a diagram illustrating an example enhanced communications system such as a UC system, where embodiments may be implemented for dynamically enabling user logging by processing message tags;

FIG. 2 illustrates message dialog flow among system components;

FIG. 3A-D illustrate example scenarios processing message flow;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of dynamically enabling user logging by processing message tags.

### DETAILED DESCRIPTION

As briefly described above, user logging may be enabled dynamically by processing message tags. Message tags may be headers or parameters defined by message protocols. The tags may be used to identify which message dialogs to log. Detection of a predetermined tag may initiate logging by system components. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing distributed server systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. The term “site” as used herein refers to a geographical location and may include data centers, branch offices, and similar communication sub-systems. Furthermore, the term cluster refers to a group of physical and/or virtual servers, which may provide the same service to a client in a transparent manner (i.e., the client sees a single server, while the cluster may have a plurality of servers).

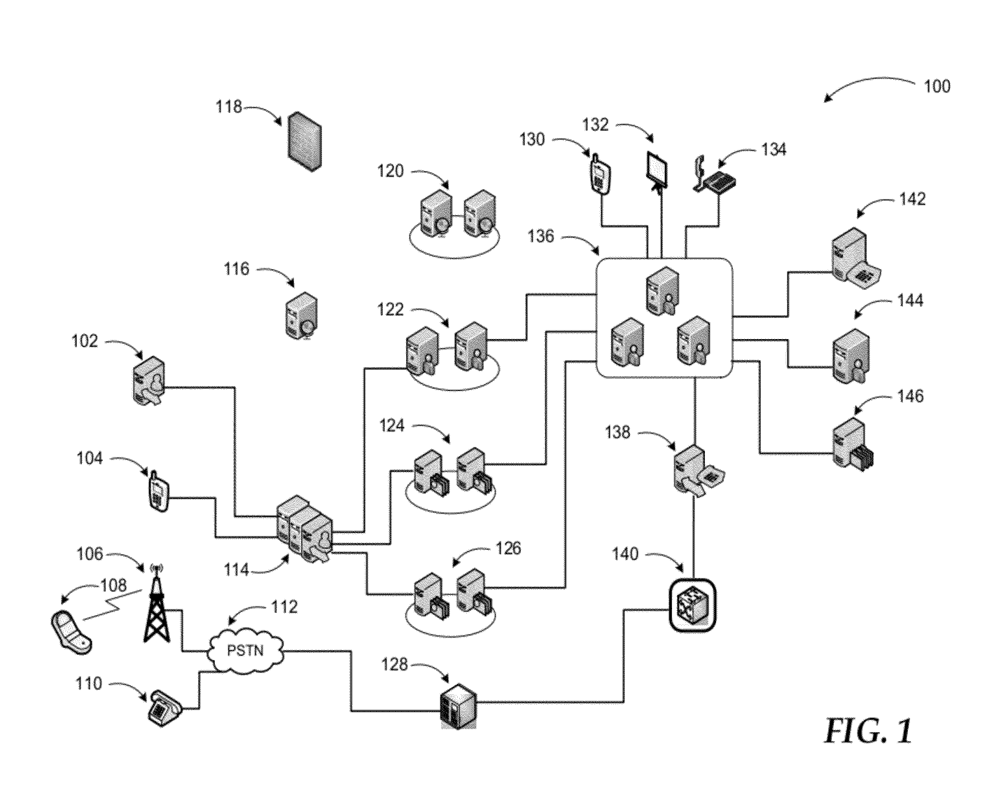

FIG. 1 includes diagram 100 illustrating an example enhanced communications system such as a UC system, where embodiments may be implemented for dynamically enabling per user logging in distributed server systems. A unified communication (UC) system is an example of modern communication systems with a wide range of capabilities and services that can be provided to subscribers. A unified communication system is a real-time communications system facilitating email exchange, instant messaging, presence, audio-video conferencing, web conferencing, and similar functionalities.

In a unified communication (UC) system such as the one shown in diagram 100, users may communicate via a variety of end devices 130, 132, 134, which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through Private Branch Exchange (PBX) 128 to a Public Switched Telephone Network (PSTN) 112. Further communications through PSTN 112 may be established with a telephone 110 or cellular phone 108 via cellular network tower 106. End devices 130, 132, 134 may include any type of smart phone, cellular phone, any computing device executing a communication application, a smart automobile console, and advanced phone devices with additional functionality.

The UC system shown in diagram 100 may include a number of servers performing different tasks. For example, edge servers 114 may reside in a perimeter network and enables connectivity through UC network(s) with other users such as remote user 104 or federated server 102 (for providing connection to remote sites). A Hypertext Transfer Protocol (HTTP) reverse protocol proxy server 116 may also reside along the firewall 118 of the system. Edge servers 114 may be specialized for functionalities such as access, web conferencing, audio/video communications, and so on. Inside the firewall 118, a number of clusters for distinct functionalities may reside. The clusters may include web servers for communication services 120, director servers 122, web conferencing servers 124, and audio/video conferencing and/or application sharing servers 126. Depending on provided communication modalities and functionalities, fewer or additional clusters may also be included in the system.

The clusters of specialized servers may communicate with a pool of registrar and user services servers 136. The pool of registrar and user services servers 136 is also referred to as a data center. A UC system may have one or more data centers, each of which may be at a different site. Registrar servers in the pool register end points 130, 132, and 134, and facilitate their communications through the system acting as home servers of the end points. User services server(s) may provide presence, backup monitoring, and comparable management functionalities. Pool 136 may include a cluster of registrar servers. The registrar servers may act as backups to each other. The cluster of registrar servers may also have backup clusters in other data servers as described later.

Mediation server 138 mediates signaling and media to and from other types of networks such as a PSTN or a cellular network (e.g. calls through PBX 128) together with IP-PSTN gateway 140. Mediation server 138 may also act as a Session Initiation Protocol (SIP) user agent. In a UC system, users may have one or more identities, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method. SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

Additional components of the UC system may include messaging server 142 for processing voicemails and similar messages, application server 144 for specific applications, and archiving server 146. Each of these may communicate with the data center pool of registrar and user services servers 136. Various components of the system may communicate using protocols like SIP, HTTP, and comparable ones.

As mentioned previously, UC system is a distributed server system. Individual components (e.g. servers) of the system, according to some embodiments, may process message tags to dynamically enable user logging. The components may receive multiple message dialogs from multiple sources. Message dialogs may be composed of a single message or multiple messages sent to various components of a distributed system. The messages may be formatted using a variety of protocols to serve the system requirements.

Message tags according to embodiments may be headers or parameters of messages. A message header may carry an identifier describing the message. An individual component may read the message header and start logging operations for recognized identifiers. Alternatively, recognition of a message parameter such as a key and value pair containing message identifier information may cause the component to log the message.

While the example system in FIG. 1 has been described with specific components such as registrar servers, mediation servers, A/V servers, and similar devices, embodiments are not limited to these components or system configurations and can be implemented with other system configuration employing fewer or additional components. Dynamically enabling user logging by processing message tags may be distributed among the components of the system depending on component capabilities and system configuration. Furthermore, embodiments are not limited to unified communication systems. The approaches discussed here may be applied to any data exchange network environment with distributed servers using the principles described herein.

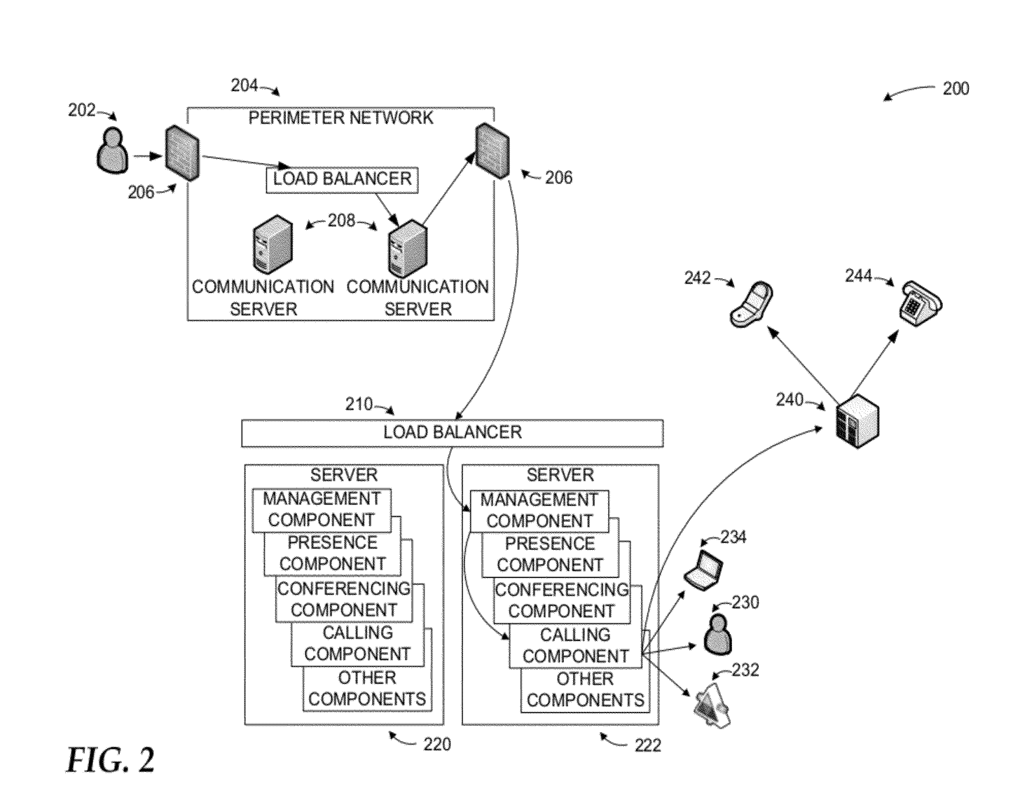

FIG. 2 illustrates message dialog flow among system components. Diagram 200 displays complexity of message logging in a distributed system. A user 202 in communication with a user 230 may engage in multiple message dialogs utilizing multiple protocols. An example message dialog such as a voice over internet protocol (VOIP) communication may initially be transmitted from a perimeter network 204. The perimeter network may have multiple firewalls 206 managing flow of traffic into and out of the network. Communication traffic admitted through the network firewalls 206 may go to load balancing components of the network that may transmit the communication dialog to available resources. An available resource may be a communication server 208 that may process the message dialog and transmit to destination through exit firewall. An exit firewall may further filter the outgoing message based on organizational policies to meet the organizational communication requirements. The exit firewall may transmit the message dialog to destination system.

According to other embodiments, an external system may have a load balancing component that transmits message dialogs to resources 220 and 222. A load balancer 210 may transmit the message dialog from user 202 to an available resource such as server 222. Server 222 may be a communication server having multiple components to manage communications such as audio, visual, text, and other communication formats. Some of the components of the server may include management component which may process the message and determine which component to utilize for message processing. Other example components may include a presence component, a conferencing component, a calling component, and other components. Each component may have its individual logging sub system. In an example scenario the management component may detect a unique identifier on the VOIP message tag and enable logging for the VOIP message dialog to record management related events. Component management related events may be control related decisions regarding to which component may be utilized to process the message dialog.

In other embodiments, the management component may transfer an example message dialog such as a VOIP communication to a calling component. Each component may be capable of processing the message tag and enable component level logging. The calling component may process the message tag and determine whether to enable logging for the message dialog. In SIP or HTTP protocols, message header may serve as the message tag. In an XML formatted message, an XML parameter may serve as the message tag. The XML parameter may be a node, a parameter, or an attribute. A calling component may be configured to recognize a header or a parameter on the message and enable logging. Logging may be accomplished in a variety of ways. The logging may be external and be always active. The component processing the message header may route logging data to the logger based on the recognition of the message tag. The message tag processing component such as the calling component may log portions of the message, the entire message, system events based on message configuration or other log data as required by the system configuration. Alternatively, the message tag processing component may enable logging locally and save log data to a local resource such as local data storage or a local database.

In other embodiments, the communication server 222 may transmit the message dialog to user 230. Alternatively the message dialog may be transmitted to a client computer 234 or a web client 232. All end devices receiving the message dialog may have message tag processing capabilities to enable logging of the incoming message. Logging in end points may be enabled similarly to the communication server 222 as described above. Additionally, the communication server may transfer the message dialog to PSTN/PBX devices 240 to route the message dialog to end devices such as cellular phone 242 and telephone 244.

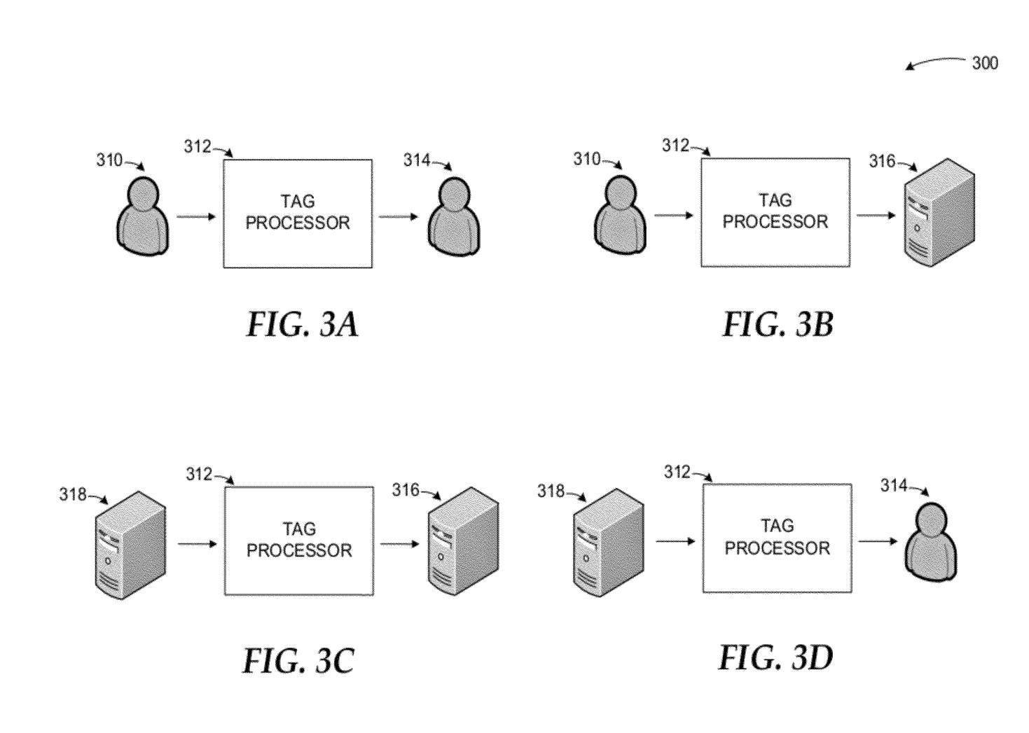

FIGS. 3A-D illustrate example scenarios processing message flow. Diagram 300 shows example message processing scenarios between users and servers. In FIG. 3A, user 310 may communicate with user 314. The message dialog may be processed by tag processor 312. In a user to user direct communication, the message sent by user 310 may be tagged to enable logging. The message generator may add a unique identifier to the tag to direct the logging process. An example may be to log a part of the message or the entire message. The tag processor may process the message, locate the tag, and compare its attributes to logging requirements. Upon matching, the tag processor may initiate logging based on the system's logging configuration.

In an embodiment, logging may be enabled continuously and the tag processor may route the logging data to the logger for recording. Upon logging determination, the tag processor may transmit the message while keeping the tag intact. Additionally, once logging on a certain tag is initiated, any subsequent message having the same tag may be logged until a system interrupt or other similar stop message. The logging stop message may simply be an alteration or removal of the tag from a message by the user or it may be system defined event such as timed stop. Removal of the tag from the message may also disable logging.

In FIG. 3B the user 310 may have a message dialog with server 316. The tag processor 312 may process message tags to determine whether to enable logging for the message dialog. An example may be a user communicating with an automated telephone customer service system where the tag processor may enable logging for audio messages containing tags for logging. The logged audio messages may be used for quality control determinations or other business processes. Alternatively, in FIG. 3C the tag processor may process message tags for message dialog between servers 318 and 316. The messages may be communications utilizing HTTP protocol to exchange data in one example implementation. The tag processor may read and process the message headers to determine what to log. In other embodiments, the tag processor may process message dialog tags between server 318 and a user 314. In one example scenario, the tag processor may process message tags for an appointment reminder system calling a user.

The systems and implementations of dynamically enabling user logging by processing message tags discussed above are for illustration purposes and do not constitute a limitation on embodiments. Dynamic logging may be enabled by processing message tags employing other modules, processes, and configurations using the principles discussed herein.

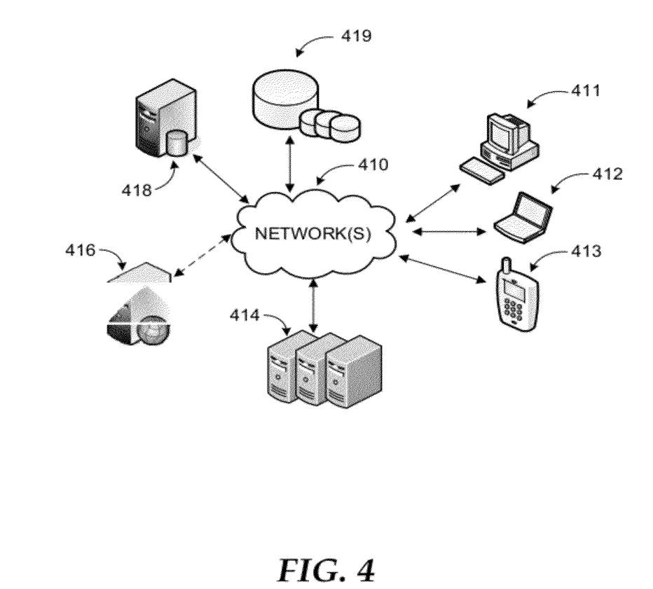

FIG. 4 is an example networked environment, where embodiments may be implemented. A tag processor algorithm may be implemented via software executed over one or more servers 414 or a single server (e.g. web server) 416 such as a hosted service. The platform may communicate with client applications on individual computing devices such as a smart phone 413, a laptop computer 412, or desktop computer 411 (‘client devices’) through network(s) 410.

As discussed above, user logging may be dynamically enabled by processing message tags from a communication server according to some embodiments. Each component of the server may process tags individually to enable logging in different capacities. Upon processing, a tag processor may transmit the message dialog to the client devices 411-413.

Client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to dynamically enable logging by processing message tags. Furthermore, the networked environments discussed in FIG. 4 are for illustration purposes only. Embodiments are not limited to the example applications, modules, or processes.

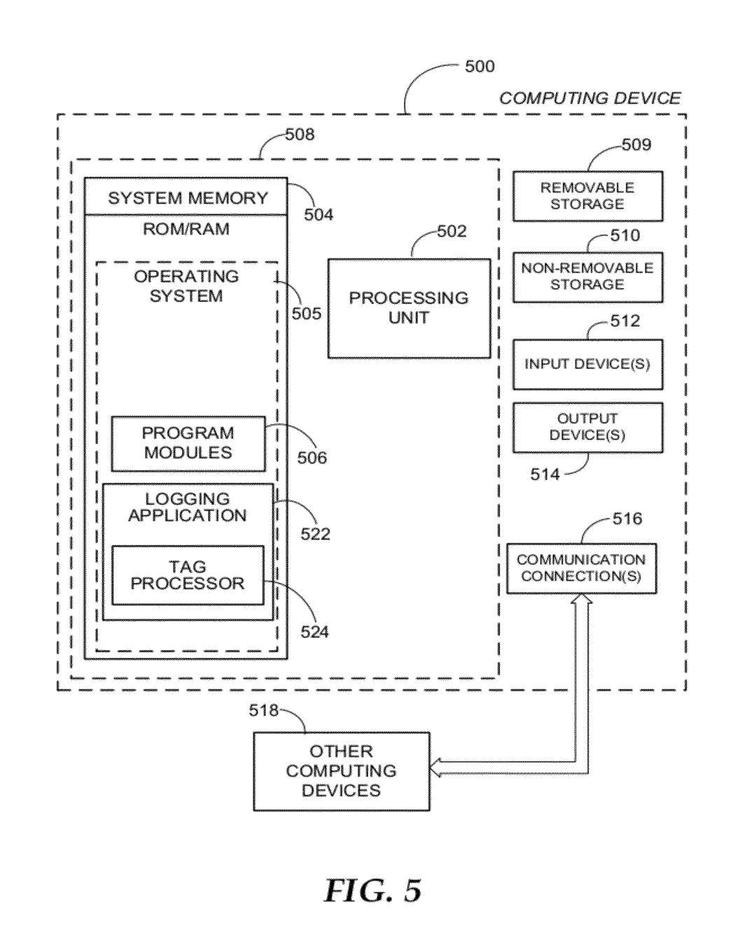

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be a server that enables dynamic logging by processing message tags and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, logging determination application 522, and tag processor 524.

Logging application 522 may be part of a component that processes a message for transmission. Tag processor 524, which may be a part of logging application 522, may read a message tag and initiate logging based on message and system criteria. Logging may be enabled based on a matching set of tag data to logging criteria of the component. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, and includes any information delivery media. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

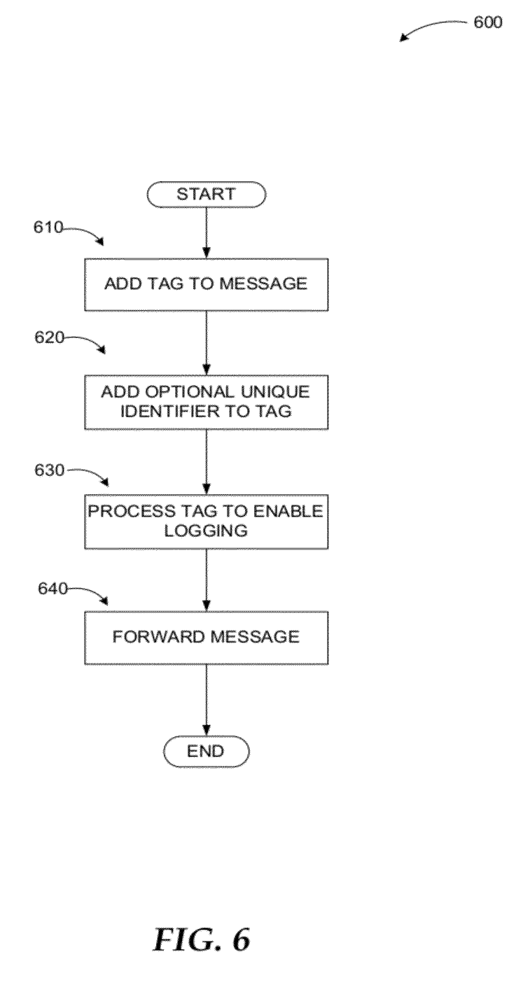

FIG. 6 illustrates a logic flow diagram for a process of dynamically enabling user logging by processing message tags according to embodiments. Process 600 may be implemented by a server in a distributed environment providing services to clients.

According to some embodiments, the tag may be a protocol-dependent identifier. For example, in a system using Session Initiation Protocol (SIP) or Hypertext Transfer Protocol (HTTP), the tag may be a header. In a system using Extensible Markup Language (XML), the tag may be a node, a parameter, or an attribute depending on the schema of the document.

In an example distributed system, a message that is sent between multiple components of the system may be associated with a tag to indicate that other components should log details related to its processing. If the processing of a tagged message requires the creation of a new message, the new message may also be tagged, even if it is in a different protocol. This tag may indicate to components any processing related to the new message is to be logged as well. When forwarding a tagged message to other components, the tag may be left in place. When responding to a tagged message, the response may also be tagged. Furthermore, tags may optionally contain a unique identifier to be used by logging tools to differentiate unrelated message dialogs.

Using tags in messages to determine logging by distributed components, a system according to embodiments may eliminate or substantially reduce noise from other traffic by allowing components to trace only processing related to tagged messages. Administrators may not need to guess on which machines to enable logging or which components are affected. Components may automatically log when told to do so. Collecting the logs may be easily scriptable and allow capture of related call logs related to a dialog. For example, if a new message is generated that does not contain a user identifier (e.g. URI), components may still trace its processing. A system according to embodiments also allows logging related to multiple message dialogs or users concurrently. The unique identifier may be used as a filter on a single log file or as part of a log file's name.

Process 600 begins with operation 610, where the message generator may add a tag to a message to enable logging. The message generator may be part of the distributed system processing the message. Alternatively, the message generator may be part of the client application generating the message. The added tag may be a message parameter or a message header. According to other embodiments, the tag may be added by someone processing the message in addition to or instead of by the party generating the message. For example, a component processing the message might see that the message came from a specific user or server that an administrator has flagged. Then, the component receiving the message may add a tag so that all future components will log the processing of the message. In operation 620, the message generator may add an optional unique identifier to the tag. The unique identifier may be used as a signal to direct the logging process. An example may be matching the identifier against predetermined logging configuration to log partial message or whole message.

At operation 630, the message tag may be processed. Processing the message tag may determine whether that particular message should be logged. Processing the message tag may involve reading the message header or a message parameter depending on the used message protocol. At operation 640, the tagged message may be forwarded to its destination while keeping the tag in intact.

The operations included in process 600 are for illustration purposes. Dynamically enabling logging by processing message tags according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for dynamic logging in a distributed system by processing message tags, the method comprising:
adding a tag to a message;
as the tagged message is being processed in at least one of a plurality of components of the distributed system, detecting the tag;
in response to detecting the tag, enabling logging of the message by one of a component processing the message and another component of the distributed system; and
continuing to process the message.

2. The method of claim 1, wherein the tag is a message header.

3. The method of claim 1, wherein the tag is a message parameter.

4. The method of claim 3, wherein the message parameter comprises a key and a value pair encoding message identifier information.

5. The method of claim 1, further comprising:
including a unique identifier in the tag such that a logging component is enabled to differentiate unrelated message dialogs.

6. The method of claim 1, further comprising:
in response to detecting the tag, enabling local logging of the message.

7. The method of claim 1, further comprising:
in response to detecting the tag, enabling external logging of the message.

8. The method of claim 1, further comprising:
in response to detecting the tag, enabling logging a portion of the message.

9. The method of claim 1, further comprising:
in response to detecting the tag, enabling logging of the message in its entirety.

10. The method of claim 1, further comprising:
when forwarding the message, keeping the tag intact.

11. The method of claim 1, further comprising:
when forwarding a response to the message, keeping the tag intact in a response message.

12. A server in a distributed system for processing messages between components of the distributed system, the server comprising:
a memory storing instructions;
a processor coupled to the memory, the processor executing at least one message processing application in conjunction with the instructions stored in the memory, wherein the message processing application is configured to:
detect a tag included in a message being processed;
if no tag is detected in the message being processed, insert a tag to the message, wherein the tag is one of a header and a parameter;
in response to detecting the tag, enable logging of the message by one of the server and another component of the distributed system; and
continue to process the message.

13. The server of claim 12, wherein the message processing application is further configured to transmit the message to a continuous logger for recording.

14. The server of claim 12, wherein the message processing application is further configured to:
if the processing of the message requires creation of a new message, inserting a tag to the new message indicating to other components of the distributed system that processing of the new message is to be logged.

15. The server of claim 14, wherein a type of the tag inserted to the new message is determined based on a communication protocol employed by the server.

16. The server of claim 15, wherein the type of the tag in the processed message and the type of the tag in the new message are different.

17. The server of claim 12, wherein the message processing application is further configured to enable logging of processing related to at least one of a plurality of message dialogs and messages associated with a plurality of users concurrently.

18. A computer-readable storage medium with instructions stored thereon for enabling dynamic logging of message processing in a distributed system, the instructions comprising:
adding a tag to a message by one of a creating application and a processing component of the distributed system;
as the tagged message is being processed in at least one of a plurality of components of the distributed system, detecting the tag;
in response to detecting the tag, enabling logging of the message by one of a component processing the message and another component of the distributed system; and
continuing to process the message by one of:
forwarding the message while keeping the tag intact;
forwarding a response to the message while keeping the tag intact in a response message; and
creating of a new message related to the processed message by inserting a tag to the new message indicating to other components of the distributed system that processing of the new message is to be logged.

19. The computer-readable storage medium of claim 18, wherein the instructions comprise:
in response to detecting the tag, enabling at least one from a set of: local logging of the message, external logging of the message, logging a portion of the message, and logging the message in its entirety.

20. The computer-readable storage medium of claim 18, wherein the tag is one of: a message header if the distributed system employs one of a Session Initiation Protocol (SIP) and a Hyper Text Transport Protocol (HTTP), and one of a node, a parameter, and an attribute if the distributed system is employing extensible markup language (XML).
